(19) United States
(12) Patent Application Publication
(10) Pub. No.: US 2026/0025685 A1
(43) Pub. Date: Jan. 22, 2026

(54) ADAPTIVE DEVICE MEASUREMENT EXECUTION

(71) Applicant: Dell Products L.P., Round Rock, TX (US)

(72) Inventor: Ali Esswie, Calgary (CA)

(21) Appl. No.: 18/774,596

(22) Filed: Jul. 16, 2024

(51) Int. Cl. H04W 24/10; H04L 5/00; H04W 80/02

(52) U.S. Cl. CPC H04W 24/10; H04L 5/0051; H04W 80/02

(57) ABSTRACT

A serving radio network node may indicate to a user equipment one or more upcoming radio resource management measurement occasion(s)/gap(s) during which the user equipment is to avoid suspending communication with the node and is to avoid measuring signal strength values corresponding to neighboring nodes. Instead, during indicated upcoming gap(s), the serving node may transmit buffered downlink traffic packets to the user equipment to avoid violating a latency criterion corresponding to the downlink traffic packets, or the user equipment may transmit buffered uplink traffic packets do the serving node to avoid violating a latency criterion corresponding to the uplink traffic packets. Transmitting of packets during the upcoming gap(s) may be based on determining that user equipment movement or a signal strength change rate does not correspond to a likely need that the user equipment be handed over to a neighboring node soon after the indicated measurement gap(s).

### REFERENCE TO RELATED APPLICATIONS

The subject patent application is related to U.S. patent application Ser. No. ______, filed ______, and entitled “TRAFFIC-DRIVEN RADIO RESOURCE MEASUREMENT RELAXATION” (docket no. 138878.01/DELLP1258US), the entirety of which application is hereby incorporated by reference herein.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose, on a given RAN resource, loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise analyzing, by a radio network node comprising at least one processor, at least one session characteristic, corresponding to at least one communication session associated with at least one user equipment, with respect to at least one resource management measurement gap measurement criterion to result in at least one analyzed session characteristic. Based at least on the at least one analyzed session characteristic being determined to satisfy the at least one resource management measurement gap measurement criterion, the method may further comprise facilitating, by the radio network node, transmitting, to the at least one user equipment, at least one resource management measurement gap measurement modification indication indicative of at least one resource management measurement gap measurement modification to be implemented by the at least one user equipment during at least one resource management measurement gap.

The method may further comprise, facilitating, by the radio network node, transmitting, during the at least one resource management measurement gap, traffic associated with the at least one user equipment.

The at least one resource management measurement gap measurement criterion may comprise at least one of: at least one mobility criterion to be applied to an estimated speed of movement of the at least one user equipment, or at least one coverage level change criterion to be applied to an estimated rate of change of signal strength, at the at least one user equipment, associated with the radio network node.

The radio network node may be a serving radio network node that is facilitating the at least one communication session. The at least one resource management measurement gap measurement modification indication may be indicative of at least one resource management measurement gap with respect to which the at least one user equipment is to avoid measuring at least one reference signal broadcast by at least one radio network node other than the serving radio network node.

In an example embodiment, the at least one resource management measurement gap measurement modification indication may be transmitted via a downlink control information message according to at least one configured control channel resource. The downlink control information may be transmitted if the radio network node has been configured for operation according to a static measurement gap measuring mode.

In an example embodiment, the radio network node may be a serving radio network node that is facilitating the at least one communication session associated with the at least one user equipment. The at least one resource management measurement gap measurement modification indication may be transmitted during the at least one resource management measurement gap. The at least one resource management measurement gap measurement modification indication may be indicative that the at least one user equipment is to avoid measuring at least one reference signal broadcast by at least one radio network node other than the serving radio network node during the at least one resource management measurement gap. The at least one resource management measurement gap measurement modification indication may be transmitted during the at least one resource management measurement gap if the radio network node has been configured for operation according to a dynamic measurement gap measuring mode. The at least one resource management measurement gap measurement modification indication may be transmitted via a medium access control control element. The at least one resource management measurement gap measurement modification indication may be transmitted during the at least one resource management measurement gap during which the at least one user equipment is to avoid measuring the at least one reference signal.

In an example embodiment, the method may further comprise determining, by the radio network node, at least one traffic delivery characteristic, for example a latency, corresponding to the at least one communication session (e.g., corresponding to at least one protocol data unit, which may be a packet, associated with the communication session) to result in at least one determined traffic delivery characteristic, and analyzing, by the radio network node, the at least one determined traffic delivery characteristic with respect to at least one configured traffic delivery criterion (e.g., a criterion, such as a latency criterion, associated with the communications session) and with respect to the at least one resource management measurement gap to result in an analyzed determined traffic delivery characteristic. The transmitting of the at least one resource management measurement gap measurement modification indication may be further based on the analyzed determined traffic delivery characteristic being determined not to satisfy the at least one configured traffic delivery criterion. The analyzed determined traffic delivery characteristic being determined not to satisfy the at least one configured traffic delivery criterion may be based on the configured traffic delivery criterion likely being violated if a traffic packet, buffered by the radio network node, is not transmitted during the at least one resource management measurement gap. The at least one determined traffic delivery characteristic may comprise a buffered-traffic-packet age corresponding to an amount of time at least one packet associated with the at least one communication session has been buffered by the radio network node. The at least one configured traffic delivery criterion may comprise at least one latency criterion. The at least one latency criterion may be violated if, based on the packet age, or amount of time a packet has been buffered, failure to transmit the packet during the at least one resource management measurement gap would result in the packet being discarded, dropped, or otherwise becoming non-useful. The at least one latency criterion may be based on at least one quality-of-service associated with the at least one communication session.

In an example embodiment, the method may further comprise facilitating, by the radio network node, receiving, from a core network element, resource management measurement gap configuration information comprising the at least one resource management measurement gap measurement criterion.

In another example embodiment, a radio network node may comprise at least one processor configured to process executable instructions that, when executed by the at least one processor, may facilitate performance of operations that may comprise receiving, from a core network element, resource management measurement gap configuration information comprising at least one resource management measurement gap measurement skipping criterion, analyzing at least one traffic characteristic, corresponding to at least one communication session associated with a user equipment, with respect to at least one traffic criterion to result in at least one analyzed traffic characteristic, and analyzing at least one device characteristic, corresponding to the user equipment, with respect to the at least one resource management measurement gap measurement skipping criterion to result in at least one analyzed device characteristic. Based on the at least one analyzed traffic characteristic being determined to violate the at least one traffic criterion and based on the at least one device characteristic being determined to satisfy the at least one resource management measurement gap measurement skipping criterion, the operations may further comprise transmitting, to the user equipment, at least one resource management measurement gap measurement modification indication indicative of at least one resource management measurement gap measurement modification to be implemented by the user equipment during at least one resource management measurement gap.

The radio network node may be a serving radio network node that may be facilitating the at least one communication session, and wherein the at least one resource management measurement gap measurement modification indication is indicative of the at least one resource management measurement gap with respect to which the user equipment is to implement the at least one resource management measurement gap measurement modification.

In an example embodiment, the at least one resource management measurement gap measurement modification indication may be transmitted via a downlink control information message.

In an example embodiment, the at least one resource management measurement gap measurement modification indication may be transmitted via a medium access control control element during at least one of the at least one resource management measurement gap.

In an example embodiment, the at least one traffic characteristic may be a latency corresponding to at least one traffic packet associated with the at least one communication session. The latency may be based on an amount of time that the at least one traffic packet has been buffered by the radio network node. The at least one traffic criterion may be determined to be violated based on the latency exceeding, or being projected or predicted to exceed, the at least one traffic criterion upon failure by the radio network node to transmit the at least one traffic packet during the at least one resource management measurement gap. The at least one resource management measurement gap measurement skipping criterion may comprise at least one of: at least one mobility criterion to be applied to an estimated speed of movement of the user equipment, or at least one coverage level change criterion to be applied to an estimated rate of change of signal strength, at the user equipment, associated with the radio network node.

In yet another example embodiment, a non-transitory machine-readable medium may comprise executable instructions that, when executed by at least one processor of radio network equipment, may facilitate performance of operations that may comprise transmitting, to a user equipment, resource management measurement configuration information indicative of a dynamic radio resource management relaxation mode, receiving, from the user equipment during at least one resource management measurement gap, a resource management measurement gap skipping indication, and receiving, from the user equipment during at least one of the at least one resource management measurement gap indicated by the resource management measurement gap skipping indication, uplink traffic corresponding to a communication session being facilitated by the radio network equipment. In an embodiment, the resource management measurement gap skipping indication may be received via a medium access control control element. In an embodiment, the resource management measurement gap skipping indication and the traffic corresponding to the communication session may be received during a same resource management measurement gap.

In another example embodiment, a method may comprise receiving, by at least one user equipment comprising at least one processor from a serving radio network node, at least one resource management measurement gap measurement modification indication indicative of at least one resource management measurement gap measurement operation to be implemented by the at least one user equipment. Based on the at least one resource management measurement gap measurement modification indication, the method may further comprise implementing, by the at least one user equipment, the at least one resource management measurement gap measurement operation.

In an embodiment, the method may further comprise receiving, by the at least one user equipment, at least one resource management measurement gap measurement criterion information message comprising at least one resource management measurement gap measurement criterion.

In an example embodiment, the method may further comprise analyzing, by the at least one user equipment, at least one device characteristic with respect to the at least one resource management measurement gap measurement criterion to result in at least one analyzed device characteristic. Based on the at least one analyzed device characteristic being determined to satisfy the at least one resource management measurement gap measurement criterion, the method may further comprise determining, by the at least one user equipment, to implement the at least one resource management measurement gap measurement operation, which comprises avoiding measuring at least one radio parameter, corresponding to at least one radio network node other than the serving radio network node, during at least one resource management measurement gap. The method may comprise communicating traffic, corresponding to at least one communication session during the at least one resource management measurement gap, with respect to the serving radio network node.

The at least one resource management measurement gap measurement criterion may comprise at least one of: at least one mobility criterion to be applied to an estimated speed of movement of the at least one user equipment, or at least one coverage level change criterion to be applied to an estimated rate of change of signal strength, at the at least one user equipment, associated with the serving radio network node.

In an embodiment, the determining to implement the at least one resource management measurement gap measurement operation during the at least one resource management measurement gap may be further based on analyzing, by the at least one user equipment, at least one session characteristic, corresponding to the at least one communication session, with respect to at least one session criterion to result in at least one analyzed session characteristic, and determining, by the at least one user equipment, that the at least one analyzed session characteristic does not satisfy at least one session criterion.

The at least one session characteristic may comprise at least one latency associated with at least one uplink traffic protocol data unit being buffered by the at least one user equipment. The determining that the at least one analyzed session characteristic does not satisfy the at least one session criterion may comprise the at least one user equipment determining that failure to transmit at least one protocol data unit, corresponding to the at least one communication session buffered by the at least one user equipment, during the at least one resource management measurement gap is threshold likely to result in the at least one session criterion not being satisfied. The at least one session criterion may be based on at least one quality of service associated with the at least one communication session.

In an example embodiment, the at least one resource management measurement gap measurement modification indication may be received via at least one downlink control information message.

The at least one resource management measurement gap measurement modification indication may be indicative of at least one resource management measurement gap to result in at least one indicated resource management measurement gap. The at least one resource management measurement gap measurement operation may comprise avoiding, during the at least one indicated resource management measurement gap, measuring at least one reference signal corresponding to at least one radio network node other than the serving radio network node.

The at least one indicated resource management measurement gap may have been scheduled, by the serving radio network node, to occur subsequent to the receiving, by the at least one user equipment, of the at least one resource management measurement gap measurement modification indication.

In an example embodiment, the at least one resource management measurement gap measurement modification indication may be indicative of at least one resource management measurement gap to result in at least one indicated resource management measurement gap. The at least one resource management measurement gap measurement modification indication may be received during at least one of the at least one indicated resource management measurement gap via at least one medium access control control element.

In an embodiment, the method may further comprise analyzing, by the at least one user equipment, at least one device characteristic with respect to at least one resource management measurement gap measurement criterion to result in at least one analyzed device characteristic. Based on the at least one analyzed device characteristic being determined to satisfy the at least one resource management measurement gap measurement criterion, the method may further comprise determining, by the at least one user equipment, to implement the at least one resource management measurement gap measurement operation during the at least one resource management measurement gap. The method may comprise communicating traffic, corresponding to at least one communication session during the at least one resource management measurement gap, with respect to the serving radio network node.

In an example embodiment, the at least one resource management measurement gap measurement operation may comprise at least one of: avoiding, by the at least one user equipment during at least one resource management measurement gap, measuring at least one radio parameter, corresponding to at least one radio network node other than the serving radio network node; or avoiding, by the at least one user equipment during the at least one resource management measurement gap, reporting at least one radio parameter value, corresponding to at least one radio network node other than the serving radio network node, measured by the at least one user equipment during the at least one resource management measurement gap.

In another example embodiment, a user equipment may comprise at least one processor configured to process executable instructions that, when executed by the at least one processor, may facilitate performance of operations that may comprise receiving, from radio network equipment, at least one resource management measurement gap measurement modification indication indicative of at least one resource management measurement gap measurement operation to be implemented by the user equipment. Based on the at least one resource management measurement gap measurement modification indication, the method may comprise implementing the at least one resource management measurement gap measurement operation.

In an embodiment, the at least one resource management measurement gap measurement modification indication may be received via at least one downlink control information message. The at least one resource management measurement gap measurement modification indication may be indicative of at least one resource management measurement gap to result in at least one indicated resource management measurement gap. The at least one resource management measurement gap measurement operation may comprise at least one of: avoiding, during the at least one indicated resource management measurement gap, measuring at least one reference signal corresponding to at least one radio network node other than a serving radio network node associated with the radio network equipment, or reporting, during the at least one indicated resource management measurement gap, at least one measured reference signal parameter value corresponding to the at least one radio network node other than the serving radio network node.

The at least one resource management measurement gap measurement modification indication may be indicative of at least one resource management measurement gap to result in, or that may be referred to as, at least one indicated resource management measurement gap. The at least one resource management measurement gap measurement modification indication may be received during at least one of the at least one indicated resource management measurement gap via at least one medium access control control element. The at least one resource management measurement gap measurement operation may comprise at least one of: avoiding, during the at least one indicated resource management measurement gap, measuring at least one reference signal corresponding to at least one radio network node other than a serving radio network node associated with the radio network equipment; or reporting, during the at least one indicated resource management measurement gap, at least one measured reference signal parameter value corresponding to the at least one radio network node other than the serving radio network node.

In an example embodiment, the operations may further comprise analyzing, by the user equipment, at least one device characteristic with respect to at least one resource management measurement gap measurement criterion to result in at least one analyzed device characteristic. Based on the at least one analyzed device characteristic being determined to satisfy the at least one resource management measurement gap measurement criterion, the operations may further comprise determining, by the user equipment, to implement the at least one resource management measurement gap measurement operation during the at least one resource management measurement gap. The method may comprise communicating traffic, corresponding to at least one communication session during the at least one resource management measurement gap, with respect to the radio network equipment.

In yet another example embodiment, a non-transitory machine-readable medium may comprise executable instructions that, when executed by at least one processor of a user equipment, may facilitate performance of operations that may comprise, as part of a communication session with a serving radio network node, receiving, from the serving radio network node, at least one resource management measurement gap measurement modification indication indicative that the user equipment is to determine, based on analysis of at least one session characteristic corresponding to the communication session, to avoid measuring, during at least one resource management measurement gap, at least one reference signal corresponding to at least one radio network node other than the serving radio network node. The operations may further comprise analyzing the at least one session characteristic, corresponding to the communication session, with respect to at least one session criterion to result in at least one analyzed session characteristic. Based on the at least one analyzed session characteristic being determined to violate the at least one session criterion, the operations may comprise avoiding measuring at least one radio parameter, corresponding to at least one radio network node other than the serving radio network node, during at least one resource management measurement gap that is scheduled by the serving radio network node, and communicating buffered traffic, corresponding to the communication session, during the at least one resource management measurement gap, with respect to the serving radio network node.

In an example embodiment, based on the at least one analyzed session characteristic being determined to violate the at least one session criterion, the operations may further comprise transmitting, to the serving radio network node, at least one resource management measurement gap skipping indication, via at least one preamble resource associated with the at least one resource management measurement gap, indicative of an absence, during at least one future resource management measurement gap, of at least one measured parameter value corresponding to at least one radio network node other than the serving radio network node being transmitted to the serving radio network node by the user equipment. The at least one resource management measurement gap skipping indication may be transmitted via at least one medium access control control element.

### BRIEF DESCRIPTION OF THE DRAWINGS

FIG. 1 illustrates wireless communication system environment.

FIG. 2 illustrates an example environment with a radio network node indicating to a user equipment at least one radio resource management measurement gap measurement skipping.

FIG. 3 illustrates example radio resource management measurement configuration information.

FIG. 4 illustrates an example resource management measurement gap measurement modification indication.

FIG. 5A illustrates an example downlink control information message being indicative of radio resource management measurement gaps during which a user equipment is to avoid measuring radio parameters and reporting measured parameter values to a radio network node.

FIG. 5B illustrates an example medium access control control element being indicative of radio resource management measurement gaps during which a user equipment is to avoid measuring radio parameters and reporting measured radio parameter values to a radio network node.

FIG. 6A illustrates example avoiding, by a user equipment during radio resource management measurement gaps based on receiving a downlink control information message indicative of the measurement gaps, measuring or reporting radio parameters.

FIG. 6B illustrates example medium access control control element being indicative of radio resource management measurement gaps during which a user equipment is to avoid, or has determined to avoid, measuring radio parameters and reporting measured radio parameter values to a radio network node.

FIG. 7 illustrates an example timing diagram of an example embodiment of a radio network node indicating to a user equipment at least one radio resource management measurement gap, or measurement occasion, during which the user equipment is to avoid measuring or reporting radio parameter measurement values.

FIG. 8 illustrates an example timing diagram of an example embodiment of a user equipment avoiding measuring or reporting radio parameter measurement values based on receiving a resource management measurement gap measurement modification indication from a serving radio network node.

FIG. 9 illustrates a flow diagram of an example embodiment method of training a beam determining learning model based on information measured by user equipment and delivering traffic via a delivery beam that is predicted by the trained learning model.

FIG. 10 illustrates a block diagram of an example method embodiment.

FIG. 11 illustrates a block diagram of an example radio network node embodiment.

FIG. 12 illustrates a block diagram of an example non-transitory machine-readable medium embodiment.

FIG. 13 illustrates a block diagram of an example method embodiment.

FIG. 14 illustrates a block diagram of an example user equipment embodiment.

FIG. 15 illustrates a block diagram of an example non-transitory machine-readable medium embodiment.

FIG. 16 illustrates an example computer environment.

FIG. 17 illustrates a block diagram of an example wireless user equipment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

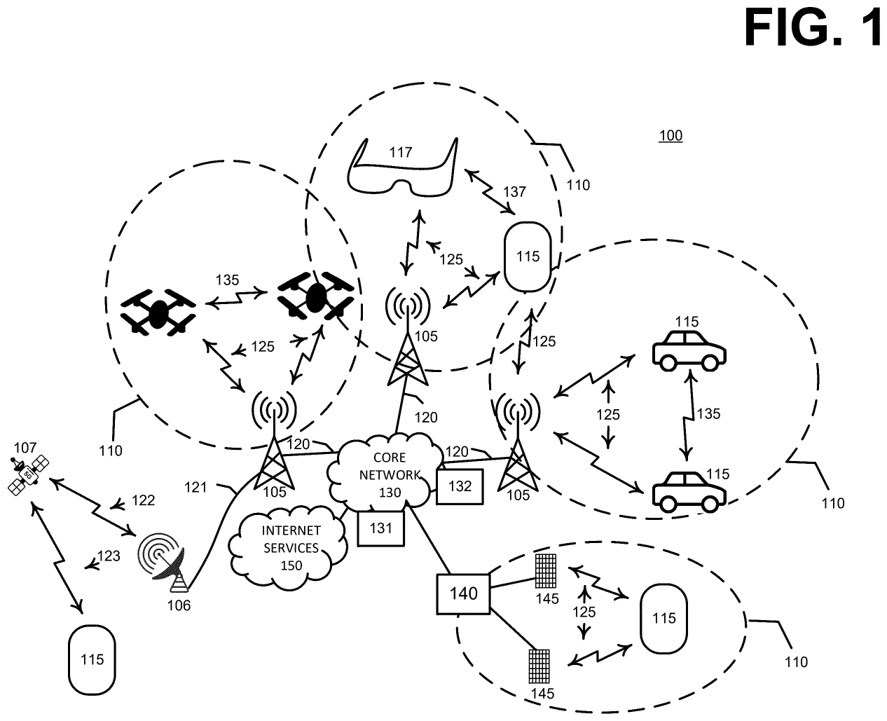

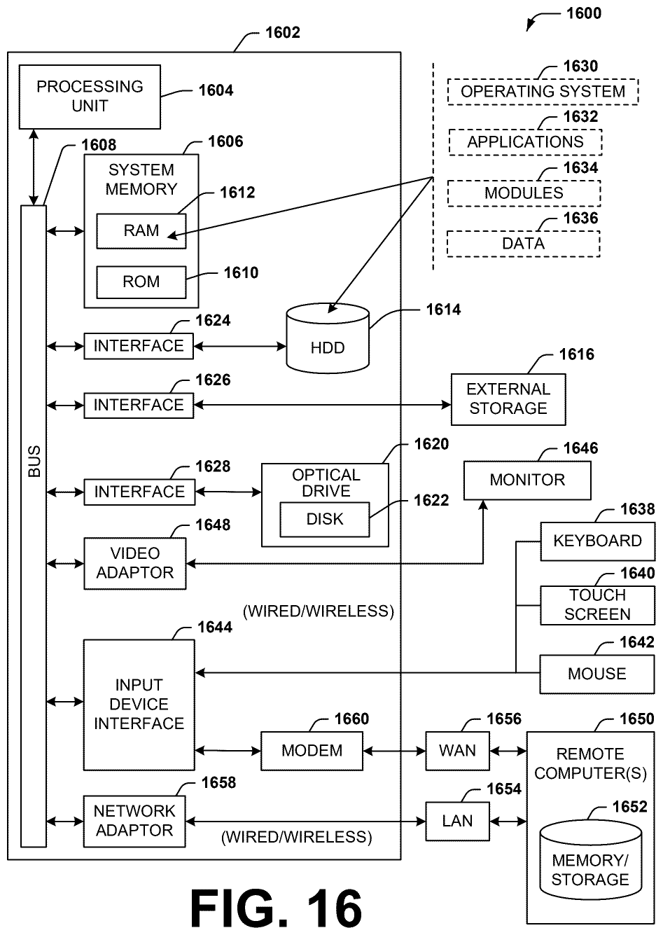

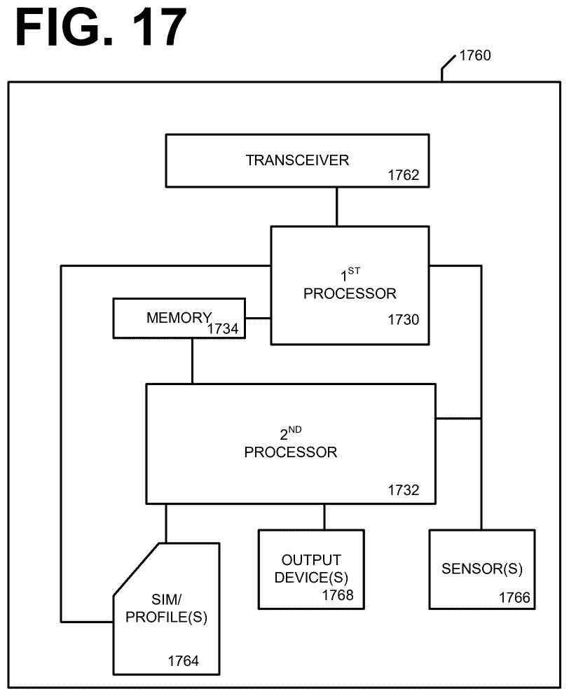

Turning now to the figures, FIG. 1 illustrates an example of a wireless communication system 100. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, may transmit or receive wireless signals with a RAN base station 105 via a long-range wireless link 125, or the UE may receive or transmit wireless signals via a short-range wireless link 137, which may comprise a wireless link with another UE device 115, such as a Bluetooth link, a Wi-Fi link, and the like. A RAN 105, or a component thereof, may be implemented by one or more computer components that may be described in reference to FIG. 16. A UE may comprise components described in reference to FIG. 17.

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (CNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling, or control signaling, that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHZ)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of

UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Radio resource management (“RRM”) measurement is a radio procedure that facilitates maintaining stable radio connections between radio network nodes and user equipment. When a user equipment is engaged with a serving radio network node in an active communication session, the user equipment periodically switches from conducting the communication session with the serving cell/RAN node to facilitate measuring, by the user equipment, coverage level (e.g., signal strength) corresponding to one or more nearby/neighboring RAN nodes. To facilitate the periodic switching, the serving RAN node configures the user equipment with periodic measurement timing gaps, or occasions, having duration long enough to facilitate the user equipment executing cell/node switching and executing RRM measurement signal strength measurements with respect to neighboring nodes, or reporting the measured signal strength values to the serving RAN node.

Accordingly, when a user equipment switches back to operation with respect to the serving cell/RAN node, the user equipment resumes the active communication session and payload exchange with the serving RAN and reports back the one or more measurement values associated with the nearby/neighboring RAN cells/nodes to the serving RAN node. Such reporting process can be the basis of triggering a handover from the current serving RAN node to any of the nearby nodes if one of the nearby/neighboring nodes may provide a better received coverage level that the current serving RAN node.

RRM measurement may facilitate reliable, prolonged radio connectivity corresponding to a communication session. By periodically checking whether nearby cells/RAN nodes other than a currently-serving RAN node would provide better coverage performance for a user equipment than a currently connected serving RAN node/cell, a user equipment may be able to transition (e.g., be handed over) to being connected with one of the neighboring RAN nodes. Thus, in case of a sudden, unpredicted radio link failure, which may result from, for example, a signal blockage or an interference signal bursts, a user equipment can be immediately handed over to an already-measured cell/node, adjacent to a currently-serving RAN node, that has been determined, based on previous measurement, to offer a coverage level/signal strength, that is acceptable to the user equipment. However, to execute RRM measurement according to conventional techniques, a currently-serving RAN node defines RRM measurement timing gaps/occasions that are considered ‘silent’ periodic periods during which a current communication session between a user equipment and the RAN node is halted, suspended, or paused. Therefore, user equipment can reliably switch from operations with the serving RAN node and execute RRM measurement procedures with respect to one or more available neighboring cells during a configured RRM measurement timing gap/period, during which the currently-serving RAN node does not send, or expect to receive, any payload with respect to the user equipment. Since RRM measurement timing gaps/occasions effectively reduce capacity with respect to a user equipment and with respect to overall network capacity corresponding to a serving RAN node since a RRM measurement gap/occasion is essentially an inactive communication period, it is desirable that configuring and scheduling of RRM measurement be optimized to minimize impact of RRM procedures on communication link capacity or on network capacity.

Configured static switching from a current session to facilitate RRM measurement with respect to cells/nodes neighboring a serving RAN node (e.g., always performing RRM measurement during a configured measurement gap) may not always be needed. For example, when user equipment devices are very close to a serving RAN node such that the user equipment experiences stable, strong signal coverage performance, switching to perform RRM measurements may waste capacity radio link or network capacity. Accordingly, a problem with using existing techniques is that RRM measurement procedures are static insofar as periodic RRM measurement timing gaps are always active regardless of radio conditions experienced by a user equipment and regardless of need for RRM measurement gaps. Thus, network capacity may be used to facilitate unneeded measurement and result in wasted network resources.

To solve problems associated with use of current RRM measurement techniques, embodiments disclosed herein may facilitate adapting RRM measurement procedures to enable measurements according to a semi-static measurement mode, which may be referred to herein as a static mode, or a dynamic measurement determining mode. According to embodiments disclosed herein, a RAN node may activate on-demand measuring of RRM measurement gap gaps/occasions to be carried out by a user equipment when there is a potential need for the user equipment to measure signal strength values corresponding to neighboring RAN nodes thus resulting in network capacity degradation being experienced only when there is a likelihood that a user equipment may need to perform RRM measurement gap measurements to facilitate potential handover to a neighboring RAN node. For example, in example embodiments disclosed herein, when a serving RAN node buffers pending latency-critical downlink payload that is directed to a user equipment that is about to switch from operation with respect to the serving RAN to facilitate measurement, during an upcoming RRM measurement gap, of signal strength values corresponding to nearby cells/nodes, the serving RAN node can, on an on-demand basis, deactivate one or more of the upcoming RRM measurement gaps/occasions such that the buffered, latency-stringent traffic can be timely delivered to the user equipment if coverage/signal strength conditions corresponding to the user equipment support a current connection with the serving RAN node being stable and reliable enough to safely skip measuring other RAN nodes' signals during the deactivated RRM measurement occasions. Embodiments disclosed herein may be useful with respect to both downlink and uplink communication session traffic.

Conventional RRM measurement techniques require that a static set of RRM measurement gaps/occasions be defined and that a user equipment must always measure signal parameters corresponding to reference signals broadcast by neighboring RAN nodes during the measurement gaps regardless of user equipment device or traffic conditions. Embodiments disclose herein may facilitate transforming RRM measurement operation into a semi-static measurement mode (which may be referred to as static measurement mode herein) or a fully dynamic process (e.g., referred to herein as a dynamic measurement determining mode) such that a current RRM measurement gap/occasion may or may not be skipped (e.g., a user equipment may or may not switch from a current communication session with a serving RAN to acquire measurements with respect to other radio network nodes) depending on real-time device conditions and pending/buffered traffic conditions.

Unlike with conventional techniques, wherein user equipment RRM measurement operations occur statically according to a configuration, such that a user equipment device always switches from a current serving RAN node to a nearby cell/node to perform RRM measurement during a configured RRM measurement occasions, according to embodiments disclosed herein, a user equipment may determine whether a current RRM measurement occasion is to be skipped based on real time traffic and/or coverage conditions.

### Traffic-Driven Radio Resource Measurement Relaxation.

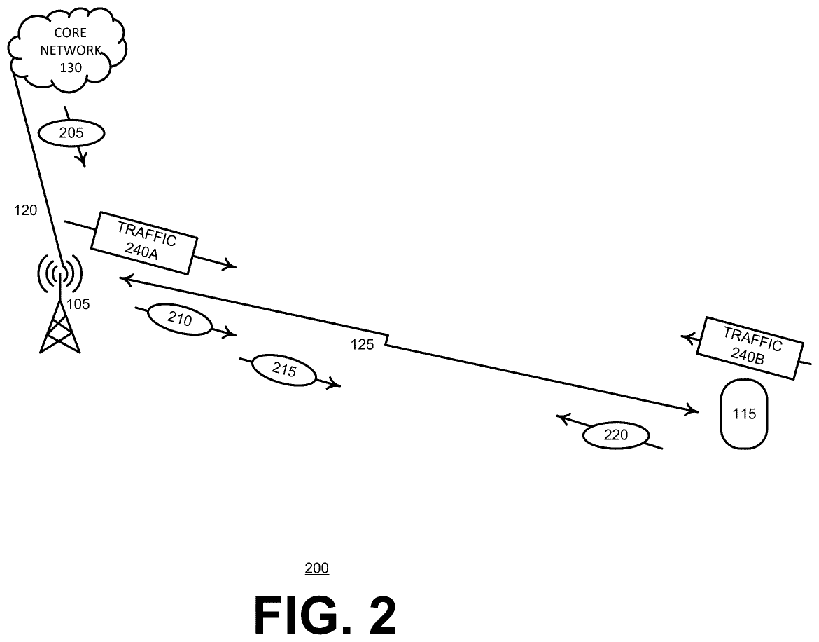

Turning now to FIG. 2, environment 200 may comprise a radio network node 105 and user equipment 115. User equipment 115 may represent more than one user equipment. One user equipment is illustrated for purposes of clarity and simplicity. RAN node 105 may receive from an element of, or component of, core network 130, radio resource management (“RRM”) measurement relaxation configuration information 205, which may be referred to as resource management measurement gap configuration information. Configuration information 205 may be indicative of at least one resource management measurement gap measurement modification that may be implemented by user equipment 115 during at least one resource management measurement gap. A resource management measurement gap may be referred to as a radio resource management measurement occasion. One or more radio resource management measurement occasions may be configured such that user equipment 115 may temporarily suspend, or pause, communication of traffic, corresponding to a communication session 240, with respect to serving RAN node 115 that may be facilitating the communication session. Radio network node 105 may transmit to user equipment 115 resource management measurement gap configuration information message 210, which may comprise the same, or similar, information as resource management measurement gap configuration information 205 received by node 105 from core network 130.

In an example embodiment, radio network node 105 may transmit to user equipment 115 at least one resource management measurement gap measurement modification indication message 215 indicative of at least one resource management measurement gap measurement modification (e.g., skipping, or avoiding, measuring or reporting a measured radio parameter values corresponding to radio network nodes other than node 105) to be implemented by the user equipment during at least one resource management measurement gap/occasion. Serving radio network node 105 may determine to transmit a resource management measurement gap measurement modification indication based on the node determining that a session criterion, for example a latency criterion associated with downlink traffic 240A that is directed to UE 115 and that is buffered by the serving node, may be violated if instead of transmitting the buffered downlink traffic during a particular resource management measurement gap/occasion because the user equipment pauses receiving traffic to measure radio parameters corresponding to other radio network nodes during the particular measurement gap and the serving node continues to buffer the traffic during the particular measurement gap. If serving RAN 105 determines that at least one resource management measurement gap measurement criterion, which may be referred to as a resource management measurement gap measurement skipping criterion, is satisfied, or is likely satisfied, the serving RAN may transmit to user equipment 115 message 215. In an example embodiment, user equipment 115 may use configuration information received in message 210 to determine to transmit, during at least one resource management measurement gap that may be indicated in message 215, protocol data units, or packets, associated with uplink traffic 240B that the user equipment may be buffering. User equipment 115 may indicate, via one resource management measurement gap skipping indication 220, indicative of an absence, during at least one future resource management measurement gap, of at least one measured parameter value corresponding to at least one radio network node other than the serving radio network node being transmitted to the serving radio network node by the user equipment. User equipment 115 may transmit skipping indication 220 via at least one preamble resource associated with at least one resource management measurement gap indicated by the skipping indication.

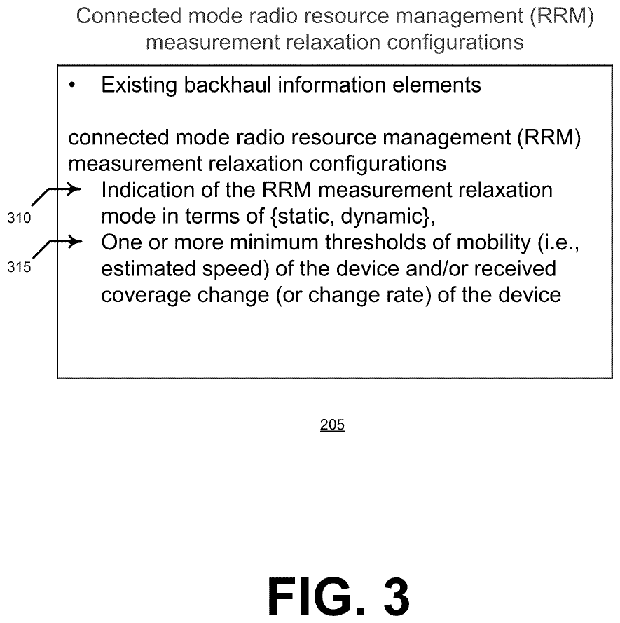

RAN node 105 may receive, from the core network 130 via backhaul interface link(s) 120, connected mode radio resource management measurement relaxation configuration information 205, which may comprise in field 310, shown in FIG. 3, an indication of an RRM measurement relaxation mode in terms of a static mode or a dynamic mode. Information 205 may comprise, in field 315 shown in FIG. 3, at least one resource management measurement gap measurement criterion, for example one or more minimum mobility thresholds applicable to analysis of an estimated speed of UE 115, or one or more received coverage change, or change rate, criterion applicable to analysis of radio channel conditions corresponding to UE 115. A static mode indication in information 205 may be indicative that RAN node 105, each time the RAN node determines there is a need for a user equipment to skip at least one upcoming RRM measurement occasion/gap, is to transmit a control channel information message indicating the RRM occasion skipping configuration information. A dynamic mode indication in information 205 may be indicative that use of downlink control channel messaging is be avoided by RAN 105 and such control signaling is avoided such that the RAN node, dynamically, or in real-time, indicates to UE 115 whether a current RRM measurement occasion is to be skipped or not. Use of a static mode to indicate at least one RRM measurement gap to be skipped may increase downlink control signaling overhead being consumed but may facilitate a low-processing load at UE 115 because the UE is configured to execute RRM measurements unless otherwise explicitly indicated. On the other hand, although use of a dynamic mode may avoid, or minimize, consumption of downlink resources to instruct UE 115 to avoid measuring of signals corresponding to nodes other than 105 during a configured RRM measurement gap, use of an alternative means (e.g., a MAC-CE) of indicating a measurement gap to be skipped may result in increased processing load at the UE.

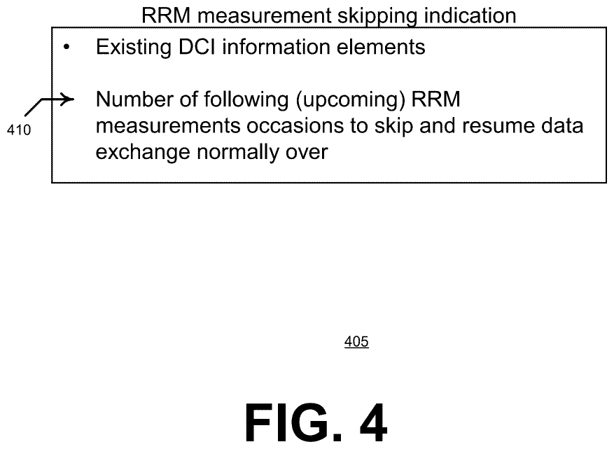

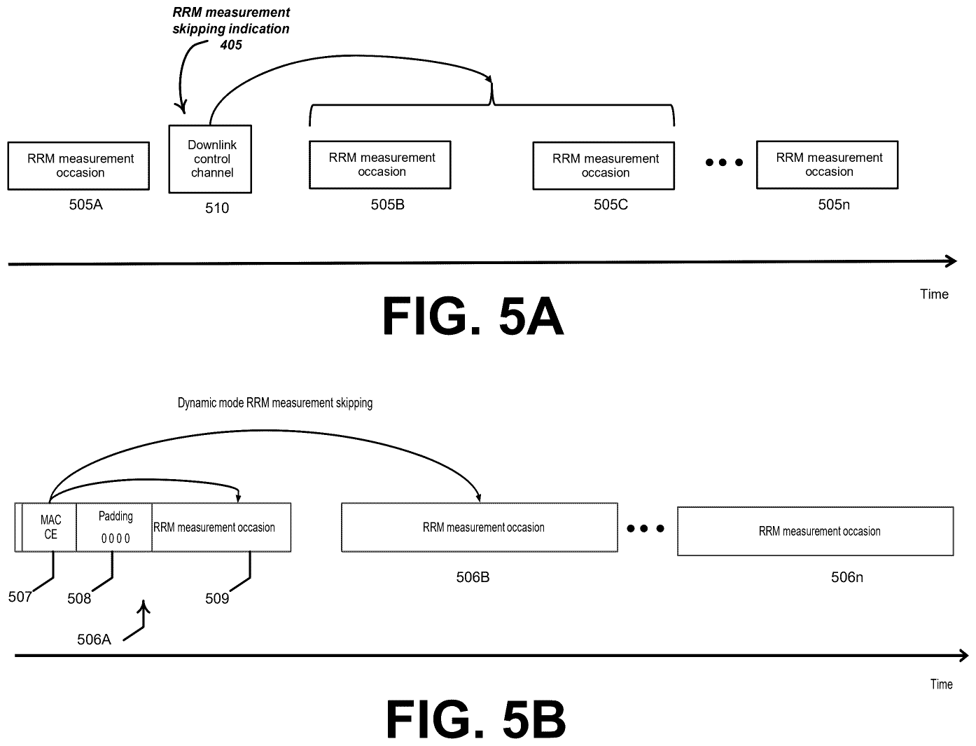

On condition of a configured static RRM measurement relaxation indicated by configuration information 205, and pending downlink traffic packets buffered by RAN 105 with respect to which a latency criterion/requirement associated with the downlink traffic may be violated if the buffered downlink traffic packets are not transmitted during at least one upcoming RRM measurement gap, and RAN 105 determines that a criterion indicated in field 315 is satisfied, RAN node 105 may transmit at least one resource management measurement gap measurement modification indication 215 indicative of at least one resource management measurement gap measurement modification to be implemented by the at least one user equipment during at least one resource management measurement gap. Indication 215 may be transmitted via a downlink control information (“DCI”) channel 510 shown in FIG. 5A. Indication 210 may comprise RRM measurement relaxation information 405, shown in FIG. 4, which may comprise in field 410 at least one indication of one or more of the upcoming RRM measurement gap/occasions 505B and 505C to be relaxed, (e.g., UE 115 may not need to measure, or may skip measuring, radio parameters pertaining to radio network nodes other than serving RAN 105 shown in FIG. 2 during gaps 505B and 505C) such that data transmission to UE 115 by RAN node 105 resumes, or continues, during indicated measurement gaps 505B and 505C.

On condition of information 205 or 210 being indicative of a dynamic RRM measurement relaxation mode and one or more pending (buffered) downlink traffic packets with respect to which at least one latency target may be violated if not transmitted during an upcoming measurement gap 506 shown in FIG. 5B, (e.g., the buffered downlink traffic packets may experience a buffering outage) and one or more criterion/minimum thresholds indicated in field 315 for activating RRM measurement relaxation is satisfied, RAN node 105 may transmit a medium access control-control element (“MAC-CE”) 507 (which may be referred to as resource management measurement gap measurement modification indication 215) during a current RRM measurement occasion 506A, indicating that measuring of radio parameters corresponding to radio network nodes other than radio network node 105 during one or more upcoming RRM measurement occasions 506 may be relaxed, or skipped, to facilitate resumption of delivery of buffered downlink data traffic. MAC-CE 507 may be appended to a zero/empty packet transmitted during occasion/gap 506A. In an example embodiment, RAN node 105 may receive, from UE 115, and decode potential uplink MAC-CEs, appended to a zero/empty packet, via a preconfigured preceding preamble resource set associated with current RRM measurement occasion 506A that may be indicative that UE 115 has skipped measuring or radio parameters during gap/occasion 506A to facilitate transmission, by the UE to the RAN node, of uplink traffic buffered by the UE. RAN node may resume transmission, or reception, of payload via respective downlink, or uplink, resources that are scheduled to overlap with an indicated relaxed (e.g., skipped) RRM measurement gap/occasion indicated by a message 215.

### Adaptive Device Measurement Execution.

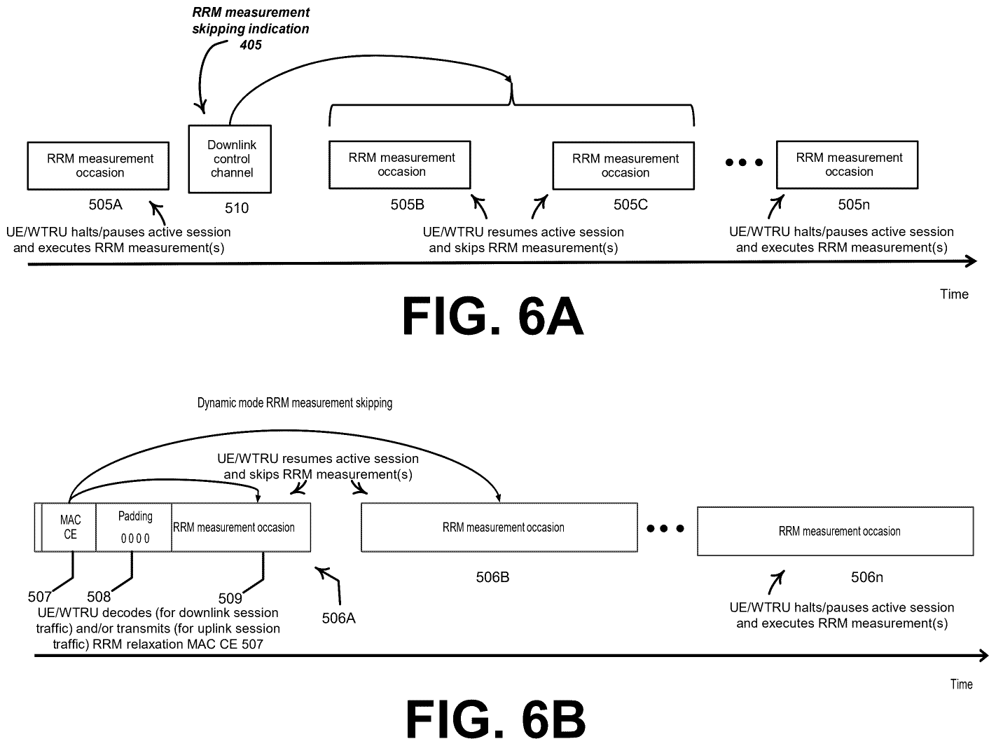

As shown in FIG. 6A, based on a static RRM measurement relaxation being indicated to UE 115 via configuration information message 210 and based on RRM measurement relaxation being indicated, as part of active downlink control information message 215, UE/WTRU 115, shown in FIG. 2, may skip measuring radio parameters during one or more upcoming RRM measurement occasions and may resume receiving of downlink data traffic 240A from the currently serving RAN node 105.

As shown by FIG. 6B, on condition of a dynamic RRM measurement relaxation mode being indicated by message 210 and a measurement gap 506 overlapping with downlink radio resources scheduled for delivery of downlink payload 240A, UE/WTRU 115 may search for, and decode, one or more medium access control-control elements (MAC-CE) 507, which may be appended to a zero/empty packet 508, according to a preconfigured preamble resource set associated with current RRM measurement occasion. After searching for a MAC-CE, UE 115 may determine the presence of MAC-CE 507, and decode MAC-CE 507 that is indicative of relaxation of one or more RRM measurement occasions 506 (e.g., MAC-CE 507 is indicative of relaxation being enabled for RRM measurement gap/occasion 506A), UE/WTRU 115 may, during gap/occasion 506A, skip measuring radio parameters corresponding to radio network nodes other than radio network node 105, and may instead resume, or continue, receiving of downlink data 204A from RAN node 105 during gap/occasion 506A.

In an example embodiment, based on message 210 being indicative of a dynamic RRM measurement relaxation mode and gap/occasion 506A being determined by UE 115 to overlap with uplink radio resources scheduled for delivery of uplink payload/packets associated with uplink traffic 240B such that if the traffic/packets is/are not transmitted during gap 506A (or at least during portion 509 thereof), or during gap 506B, a session criterion, such as a latency target/criterion associated with traffic 240B, would be violated (e.g., a session outage would occur), UE/WTRU 115 may transmit one or more MAC-CEs 507, which may be appended to a zero/empty packet 508, via a preconfigured preamble resource set associated with current RRM measurement occasion 506A, to indicate that UE/WTRU 115 may skip measuring of radio parameters corresponding to radio network nodes other than node 105 and instead may transmit the buffered uplink traffic, which would otherwise likely be dropped or discarded if not transmitted during one or more upcoming RRC measurement gap(s)/occasion(s) 506A or 506B. As shown in FIG. 6A or 6B, UE/WTRU 115 may revert to pausing, or halting, delivery of traffic 240A or 240B during at least one future gap/occasion (e.g., gap 506n) that is not indicated for measurement skipping by indication 405 in DCI 510 or as indicated by MAC-CE 507, respectively. In accordance with an indication of uplink transmission, transmitted by UE/WTRU 115 via MAC-CE 507, the UE/WTRU may resume, or continue, transmission of pending/buffered uplink traffic via scheduled uplink resources that overlap with measurement gap(s)/occasion(s) 506A or 506B.

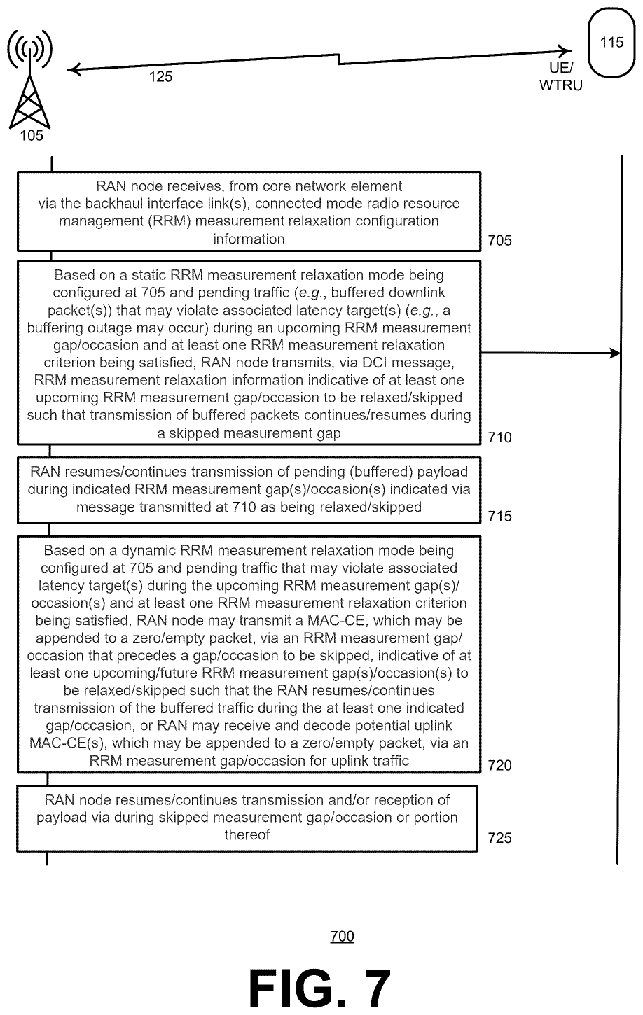

Turning now to FIG. 7, the figure illustrates a timing diagram of an example embodiment method 700 to facilitate radio network node 105 indicating to UE 115 information that may be used to determine RRM measurement gap(s)/occasion(s) during which measuring of neighboring RAN node signals may be skipped by the user equipment. At act 705, RAN node 105 may receive, from core network equipment, via backhaul interface link(s) 120 (shown in FIGS. 1 and 2), connected mode radio resource management measurement relaxation configuration information, which may be referred to as resource management measurement gap configuration information (e.g., information 205 described in reference to FIG. 2). The resource management measurement gap configuration information may comprise at least one of: at least one indication of RRM measurement relaxation mode in terms of static mode or dynamic mode; or at least one minimum threshold/criterion of mobility (e.g., estimated speed) of a user equipment device and/or at least one received coverage change, or change rate, corresponding to a user equipment device. Based on a configured static RRM measurement relaxation mode and pending/buffered downlink traffic packets with respect to which an associated latency criterion may be violated if the buffered packets are not transmitted to a user equipment to which the packets are directed during an upcoming RRM measurement gap and based on at least one threshold/criterion for activating RRM measurement relaxation likely being satisfied (e.g., a mobility characteristic or a signal strength rate of change indicated in the resource management measurement gap configuration information corresponds to the user equipment not moving rapidly with respect to RAN node 105), the RAN node may transmit, at act 710 via a downlink control channel, a DCI message (e.g., message 210 described in reference to FIG. 2) that may comprise RRM measurement relaxation information and that may be referred to as a resource management measurement gap measurement modification indication. The indication transmitted at act 710 may comprise at least one of: at least one indication of at least one upcoming RRM measurement occasions to be relaxed, (e.g., during which switching to measure neighboring RAN signals by UE 115 is to be skipped) such that data reception from RAN 105 to UE 115 resumes or continues during the indicated at least one RRM measurement occasion/gap. At act 715, RAN node 105 may resume/continue transmission of pending/buffered downlink payload during at least one of the at least one RRM measurement occasions indicated in the message transmitted to UE 115 at act 710.

Based on a dynamic RRM measurement relaxation being indicated in the configuration information received at act 705, based on buffered downlink traffic likely to violate an associated latency target/requirement if not transmitted during an upcoming RRM measurement gap, and based on at least one criterion (e.g., mobility or signal strength change criterion indicated at act 705) for activating RRM measurement relaxation being satisfied based on information reported by UE 115, RAN node 105 may transmit, at act 720, a medium access control-control element, appended to a zero/empty packet, during a preconfigured RRM measurement occasion, wherein the MAC-CE is indicative of at least one upcoming RRM measurement occasion during which measurement of neighboring RAN node signals by UE 115 is to be avoided. At act 720, RAN 105 may transmit the buffered downlink traffic to UE 115 during an upcoming RRM measurement gap indicated at act 720.

In an embodiment, based on configuration information indicated at act 705 being indicative of a dynamic measurement determining mode and based on RAN 105 having transmitted to, or indicated to, user equipment 115 an indication indicative of dynamic measurement determining mode operation, and based on RAN 105 receiving, during a configured RRM measurement gap from user equipment 115 at act 720, and decoding an uplink MAC-CE, which may be appended to a zero/empty packet, according to a preconfigured preamble resource set associated with the RRM measurement gap, RAN node 105 may receive, from UE 115 at act 725, uplink traffic during an upcoming RRM measurement gap or during the RRM measuring gap during which the uplink MAC-CE was received by the RAN node.

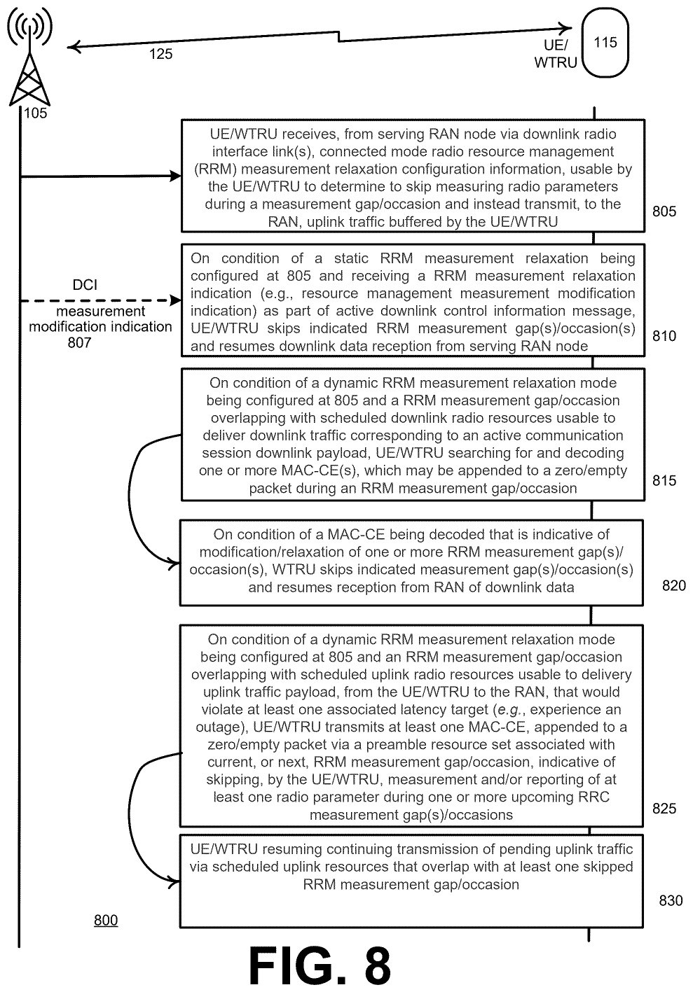

Turning now to FIG. 8, the figure illustrates a timing diagram of an example embodiment method 800 to facilitate connected-mode user equipment 115 skipping measurement or reporting procedures during an RRM measurement gap/occasion configured to be used by the user equipment measure signal parameter values with respect neighboring radio network nodes other than RAN node 105. At act 805, user equipment 115 may receive, from serving RAN node 105 via downlink radio interface link(s) 125, connected mode RRM measurement relaxation configuration information, for example configuration information received in message 210 as described in reference to FIG. 2. Message 210 may comprise information that may be referred to as resource management measurement gap measurement criterion information. A message received at act 805 may comprise at least one of: at least one indication of an RRM measurement relaxation mode in terms of a static mode or a dynamic mode; or at least one resource management measurement gap measurement criterion, for example at least one minimum mobility threshold of mobility (e.g., a movement speed criterion to be applied to movement of UE 115) or a received coverage change/change rate criterion to be applied to a change rate corresponding to signal strength values reported to RAN node 105 by UE 115.

On condition of a static RRM measurement relaxation mode being configured at 805 and having received, at act 807, an RRM measurement relaxation indication/one resource management measurement gap measurement modification indication (e.g., message 215 described in reference to FIG. 2), as part of a DCI message, UE/WTRU 115 may skip one or more upcoming RRM measurement occasions indicted in the one resource management measurement gap measurement modification indication and resume/continue downlink data reception from serving RAN node 105 at act 810. The receiving of a DCI message at act 807 is illustrated by a broken line to indicate that receiving of a static measurement relaxation indication may be optional insofar as configuration information received by UE 115 at act 805 may be indicative of a dynamic RRM measurement relaxation mode.

In an example embodiment, on condition of a configured dynamic RRM measurement relaxation being indicated at act 805, and on condition of an upcoming previously configured RRM measurement gap being determined by user equipment 115 to overlap downlink radio resources scheduled by RAN 105 to deliver downlink payload traffic from the RAN node to the user equipment, UE/WTRU 115 may, at act 815, search for, and decode, at least one medium access control-control elements (MAC-CE), appended to a zero/empty packet, within or during an RRM measurement occasion/gap. On condition of detecting a MAC-CE indicating measurement relaxation/skipping of one or more RRM measurement occasions/gaps, UE/WTRU 115 may, at act 820, skip/avoid measuring, during an RRM measurement gap indicated by the MAC-CE, reference signals corresponding to neighboring RAN nodes other than RAN node 105, and may resume receiving of downlink date from RAN node 105 during the at least one measurement gap indicated by the decoded MAC-CE.

In an example embodiment, based on a dynamic RRM measurement relaxation mode being configured at act 805, and based on UE 115 determining that at least one buffered uplink traffic packet to be transmitted to RAN node 105 is scheduled for transmission to RAN 105 during an upcoming configured RRM measurement gap such that measuring signals corresponding to neighboring RAN nodes other than RAN node 105 during the upcoming configured RRM measurement gap would likely result in a violation of a latency target/requirement associated with the buffered uplink traffic packet(s) s, at act 825 UE/WTRU 115 may transmit at least one uplink MAC-CE to RAN node 105 during an RRM measurement occasion/gap. The at least one uplink MAC-CE may be appended to a zero/empty packet. The at least one uplink MAC-CE may be transmitted to RAN node 105 according to a preconfigured preceding preamble resource set associated with the RRM measurement occasion used to transmit the MAC-CE. The at least one MAC-CE message may be indicative that instead of measuring signals corresponding to other RAN nodes during an upcoming RRM measurement indicated by the at least one uplink MAC-CE, UE 115 may skip/avoid the measuring of signals corresponding RAN nodes other than RAN node 105 and may instead transmit, to RAN node 105, buffered uplink traffic during an RRM measurement gap indicated by the at least one uplink MAC-CE. At act 830, UE/WTRU 115 may resume/continue transmission of pending/buffered uplink traffic according to scheduled uplink resources that overlap with at least one RRM measurement gap indicated by an uplink MAC-CE indicated at act 825.

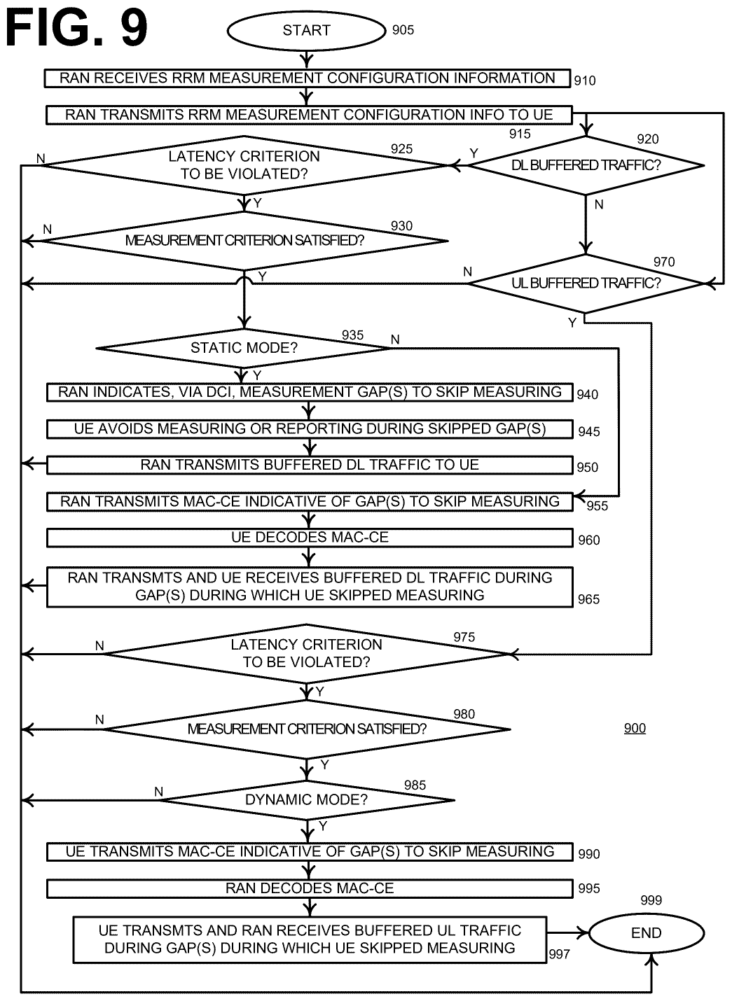

Turning now to FIG. 9, the figure illustrates a flow diagram of an example embodiment 900. Method 900 begins at act 905. At act 910, a radio network node, or a network element comprising, or corresponding to, a radio network node, may receive from core networking equipment radio resource management measurement configuration information via a radio resource management measurement configuration information message such as message 205 described in reference to FIG. 2. Message 205 may comprise information that may be referred to as resource management measurement gap configuration information. Message 205 may comprise at least one resource management measurement gap measurement criterion, for example an indication of a static measurement gap measuring mode or a dynamic measuring gap measuring mode. A measuring gap measurement mode may be referred to as a measuring gap relaxation mode, or simply a relaxation mode. Message 205 may comprise at least one resource management measurement gap configuration information comprising the at least one resource management measurement gap measurement criterion, for example a mobility criterion or a coverage criterion, either of which may be used by the serving radio network node to determine, or predict, whether a user equipment may be located relative to the serving radio network node such that a need for the user equipment to be handed over to a neighboring radio network node is unlikely during at least one upcoming radio resource management measurement occasion, which may be referred to as a resource management measurement gap. A radio network node may determine mobility of a user equipment based on changing of beams being used to serve the user equipment. Determination of a beam used, or to be used, to serve a user equipment, or determination of a signal strength corresponding to a user equipment, may be based on at least one report, transmitted by the user equipment to the serving radio network node, indicative of signal strength corresponding to the serving radio network node. At act 915, the serving radio network node (e.g., a radio network node that is facilitating a communication session with the user equipment) may transmit to the user equipment a resource management measurement configuration information message, for example message 210 described in reference to FIG. 2. Resource management measurement configuration information transmitted at act 915 may be indicative of a dynamic radio resource management relaxation mode that may be indicated in configuration message 205 received by the radio network node at act 910. The configuration information transmitted at act 915 may comprise resource management measurement gap measurement criterion information indicated in the configuration message 205 received by the radio network node at act 910. Accordingly, the user equipment may be configured with the same configuration information indicated to the radio network node by the core network at act 910.

In an example embodiment, at act 920 the serving radio network node may determine whether downlink traffic packets associated with the communication session with the user equipment may be buffered at the serving radio network node. If the serving radio network node determines that downlink traffic packets to be transmitted to the user equipment are being buffered, method 900 advances to act 925. At act 925, the radio network node may determine whether a latency criterion associated with the buffer downlink traffic packets would be violated if the radio network node does not transmit to the user equipment the buffered downlink traffic packets during an upcoming/future resource management measurement gap. If the radio network node determines that failure to transmit the buffer downlink traffic packets during an upcoming measurement gap would not violate a latency criterion associated with the buffer downlink traffic packets, method advances to act 999 and ends. However, if the radio network node determines at act 925 that a latency criterion corresponding to the buffer downlink traffic packets would be violated if the downlink traffic packets are not transmitted during an upcoming resource management measurement gap, method 900 advances to act 930. At act 930, the radio network node may determine whether a measurement criterion corresponding to the user equipment is satisfied. The measurement criterion may be a criterion indicated to the radio network node by the configuration information received at act 905. Examples of the measurement criterion that may be applied by the radio network node at act 930 may comprise a minimum mobility criterion (e.g., a minimum estimated speed of the user equipment) or a received coverage level change corresponding to the user equipment (e.g., a rate of change of reported signal strength corresponding to the serving radio network node and report it there to by the user equipment). Satisfaction of the criterion at act 930 may correspond to the radio network node determining, based on an estimated speed of the user equipment or a rate of change of reported signal strength, that the user equipment is unlikely to experience a signal strength level corresponding to the serving radio network node that necessitates handover of the user equipment to a neighboring radio network node (e.g., neighboring with respect to the serving radio network node) due to declining signal strength or increasing interference or noise. The measurement criterion analyzed at act 930 may not be satisfied, for example, if the serving radio network node determines that the user equipment may be moving away from the radio network node or a signal strength corresponding to the serving radio network node is declining in strength such that the user equipment may need to be handed over to a neighboring radio network node during an upcoming radio resource management measurement gap. If a determination is made at act 930 that the measurement criterion is not satisfied (e.g., there is a low likelihood that the user equipment will not need to be handed over to a neighboring radio network node during, or soon after, an upcoming resource management measurement gap), method 900 may advance to act 999 and ends, and the serving radio network node and the user equipment may continue to operate according to conventional techniques insofar as the user equipment may suspend, during an upcoming measurement gap, communication of traffic corresponding to the communication session, which may result in buffered downlink traffic being dropped or discarded or otherwise not delivered to the user equipment, to measure reference signal strength values corresponding to neighboring radio network nodes, and the user equipment may report the measured signal strength values corresponding to neighboring radio network nodes to the serving radio network node.

Returning to description of act 930, if a determination is made by the radio network node that device parameter values corresponding to the user equipment satisfy the measurement criterion (e.g., a movement speed or movement direction corresponding to the user equipment satisfies the mobility criterion or a reported signal strength rate of change satisfies a rate of change criterion), method 900 advances to act 935. At act 935, the radio network node may determine whether a static mode or a dynamic mode is indicated in the configuration information received at act 910. If the configuration information received at act 910 indicates a static mode, method 900 advances to act 940. At act 940, the radio network node may indicate, via a downlink control information message, at least one resource management measurement gap during which the user equipment is to skip, or avoid, suspending of the communication session to perform measurements to determine signal strength values corresponding to other radio network nodes that are neighbors with respect to the serving radio network node. The downlink control information message transmitted at act 940 may be referred to as a resource management measurement gap measurement modification indication and may be indicative of at least one resource management measurement gap measurement modification to be implemented by the at least one user equipment during at least one resource management measurement gap. A measurement gap measurement modification may comprise avoiding, by the user equipment, suspending the communication session, measuring signal strengths corresponding to neighboring radio network nodes, or reporting to the serving radio network node measured signal strengths corresponding to neighboring radio network nodes. At act 945, after receiving the resource management measurement gap measurement modification indication transmitted at act 940, the user equipment may avoid suspending the communication session, measuring signal strengths corresponding to neighboring radio network notes, or reporting to the serving radio network node the measured signal strengths. At act 950, the radio network node may transmit to the user equipment, during at least one measurement gap indicated by the indication transmitted at act 940, the buffered downlink traffic packets with respect to which an associated latency criterion may have been violated (as determined at act 925) if the user equipment had suspended the communication session during the indicated at least one measurement gap and thus had been unable to receive the buffer downlink traffic packets if the radio network node had transmitted the buffered downlink traffic packets during the at least one measurement gap indicated by the indication transmitted at act 940. Accordingly, if the serving radio network node determines that the user equipment can safely avoid suspending the communication session during a measurement gap indicated at act 940 (e.g., the user equipment is not likely to need to be handed over to a neighboring radio network node soon after the indicated measurement gap as determined at act 930), violation of a latency criterion corresponding to the buffered downlink traffic packets, as would otherwise likely occur as determined at act 925, may be avoided by transmitting the buffered traffic packets during the indicated at least one measurement gap. Method 900 advances to act 999 and ends.

Returning to description of act 935, if the radio network node determines that configuration information received at act 910 does not indicate a static mode, and instead indicates a dynamic measurement determination mode, method 900 advances to act 955. At act 955, the radio network node may transmit a medium access control control element (“MAC-CE”), during an upcoming radio resource management measurement gap. The upcoming radio resource management measurement gap may be a measurement gap that corresponds to a determination made at act 925 that if buffered downlink traffic packets are not transmitted during the measurement gap an associated latency criterion may be violated, or the upcoming resource management measurement gap may be a measurement gap configured to occur later than the measurement gap with respect to which the latency criterion was analyzed at act 925. Accordingly, because the user equipment has not yet determined to skip measuring during the measurement gap that contains the MAC-CE (e.g., the user equipment has not received a DCI message as would occur if static measurement determination mode was indicated in the information received at act 910), the user equipment may decode, at act 960, the MAC-CE during the measuring gap that comprises the MAC-CE. At act 965, during an upcoming resource management measurement gap, which may be the measurement gap that comprises, or used to deliver, the MAC-CE, the radio network node may transmit, and the user equipment may avoid suspending the communication session and instead receive, the buffered downlink traffic packets with respect to which a latency criterion was determined at act 925 to potentially be violated if the packets are not transmitted during the upcoming measurement gap indicated by the MAC-CE. Method 900 advances to act 999 and the serving radio network node and the user equipment may continue operation according to conventional techniques insofar as the user equipment suspend the communication session and require signal strength measurements corresponding to neighboring radio network nodes during configured radio resource management measurement occasions/gaps.

In another example embodiment, the user equipment, after receiving the configuration information at act 915, may determine at act 970 whether the user equipment has uplink traffic associated with the communication session with the serving radio network node, buffered in a buffer corresponding to the user equipment, that is to be transmitted to the serving radio network node. If a determination is made at act 970 that the user equipment does not have uplink traffic that is to be transmitted to the serving radio network node, method 900 advances to act 999 and ends. If the user equipment determines at act 970 that uplink traffic is buffered in a buffer corresponding to the user equipment that is to be transmitted to the serving radio network node, method 900 advances to act 975. At act 975, the user equipment determines whether a latency criterion associated with the uplink traffic packets would be violated if the traffic packets are not transmitted during an upcoming radio resource management measurement gap/occasion. If the user equipment determines that a latency criterion corresponding to the buffered uplink traffic packets would not be violated if the traffic packets were not transmitted to the serving radio network node during an upcoming measurement gap, method 900 advances to act 999 and ends. If a determination is made at act 975 that a latency criterion corresponding to the buffered uplink traffic packets would be violated if the buffered uplink traffic packets are not transmitted during an upcoming measurement/occasion, method 900 advances to act 980.

Similar to the determination made by the serving radio network node at act 930, at act 980 the user equipment may determine whether a device characteristic corresponding to the user equipment satisfies a measurement criterion. For example, if the user equipment determines that a speed or direction of movement of the user equipment, or a rate of change of a signal strength corresponding to the serving radio network node, would likely result in the user equipment needing to be handed over to a neighboring radio network node soon after an upcoming measurement gap during which the buffered uplink traffic packet(s) should be transmitted to avoid violating the latency criterion as determined at act 975, method 900 may advance to act 999 and the user equipment may suspend the communication session corresponding to the buffered uplink traffic packets to acquire signal strength measurement values corresponding to neighboring radio network nodes and report the measured signal strength values to the serving radio network node. The determination made at act 980 may be made by the user equipment by analyzing a movement speed, a movement direction, or a rate of change of signal strength corresponding to the serving radio network node with respect to criterion received from the serving radio network node at act 915.

If the user equipment determines at act 980 that analysis of a movement speed, a movement direction, or a rate of change of signal strength corresponding to the serving radio network node satisfies a criterion, for example, a criterion indicated by the serving radio network node to the user equipment at act 915, method 900 advances to act 985. At act 985, the user equipment may determine whether the configuration information received from the serving radio network node at act 915 is indicative of a dynamic measurement determination mode. If a determination made at act 985 is that the information received at act 915 does not indicate a dynamic measurement gap determination mode (e.g., the configuration information received today at 915 is indicative of a static mode), method 900 advances to act 999 and ends. If a determination is made at act 985 that a dynamic measurement gap determination mode is indicated by the configuration information received at act 915, the user equipment may transmit, to the serving radio network node, a MAC-CE during an upcoming radio resource management measurement gap/occasion indicative of at least one upcoming measurement gap/occasion, which may comprise the measurement gap used to deliver the MAC-CE, during which the UE will avoid suspending the communication session and will instead transmit, to the serving radio network node, uplink traffic packets corresponding to the communication session. At act 995, the radio network node may receive and decode the MAC-CE transmitted by the user equipment at act 990. At act 997, the user equipment may transmit to the serving radio network node, and the serving radio network node may receive, buffered uplink traffic packets during at least one upcoming radio resource management measurement gap/occasion indicated by the MAC-CE transmitted by the user equipment at act 990. The uplink traffic packets transmitted at act 997 may be uplink traffic packets buffered by the user equipment that the user equipment determined at act 975 would correspond to a latency criterion violation if the packets were not transmitted via the at least one upcoming radio resource management measurement gap/occasion indicated by the MAC-CE transmitted by the user equipment at act 990. Method 900 advances to act 999 and ends.

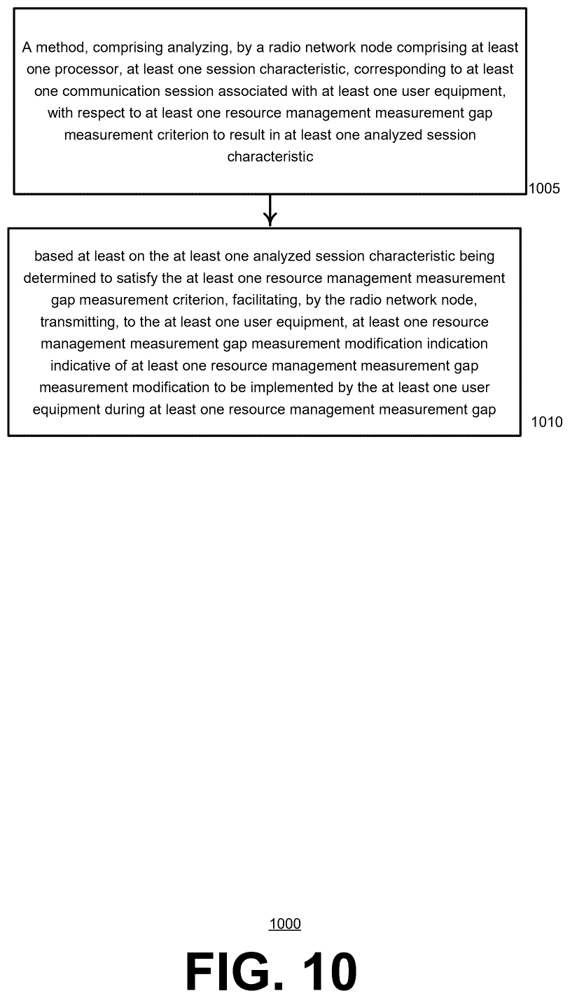

Turning now to FIG. 10, the figure illustrates an example embodiment method 1000 comprising at block 1005 facilitating, by a radio network node comprising at least one processor, analyzing, by a radio network node comprising at least one processor, at least one session characteristic, corresponding to at least one communication session associated with at least one user equipment, with respect to at least one resource management measurement gap measurement criterion to result in at least one analyzed session characteristic, and at block 1010 based at least on the at least one analyzed session characteristic being determined to satisfy the at least one resource management measurement gap measurement criterion, facilitating, by the radio network node, transmitting, to the at least one user equipment, at least one resource management measurement gap measurement modification indication indicative of at least one resource management measurement gap measurement modification to be implemented by the at least one user equipment during at least one resource management measurement gap.

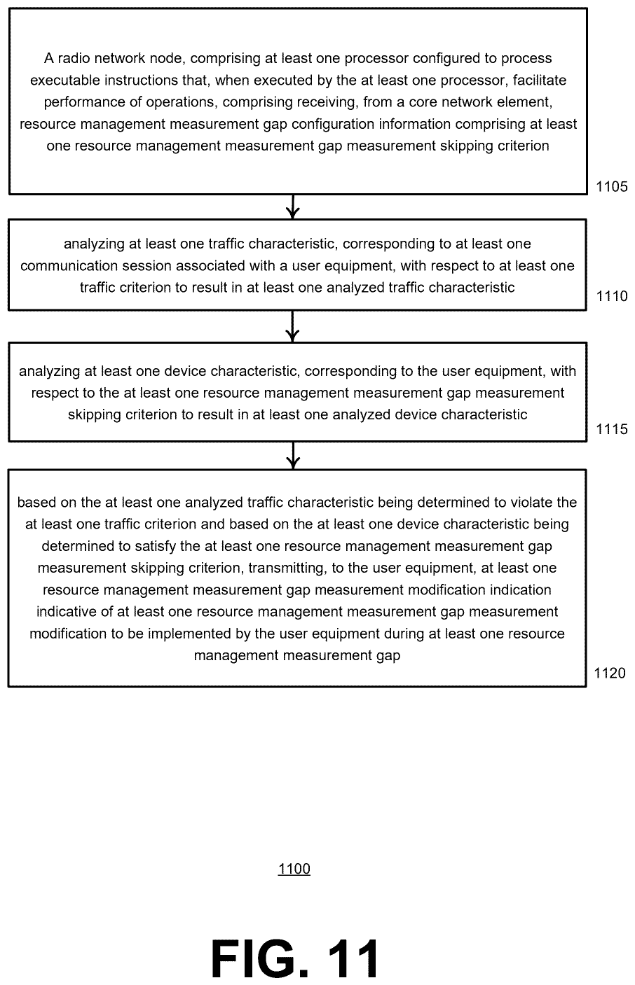

Turning now to FIG. 11, the figure illustrates a radio network node 1100, comprising at block 1105 at least one processor configured to process executable instructions that, when executed by the at least one processor, facilitate performance of operations, comprising receiving, from a core network element, resource management measurement gap configuration information comprising at least one resource management measurement gap measurement skipping criterion; at block 1110 analyzing at least one traffic characteristic, corresponding to at least one communication session associated with a user equipment, with respect to at least one traffic criterion to result in at least one analyzed traffic characteristic, at block 1115 analyzing at least one device characteristic, corresponding to the user equipment, with respect to the at least one resource management measurement gap measurement skipping criterion to result in at least one analyzed device characteristic; and at block 1120, based on the at least one analyzed traffic characteristic being determined to violate the at least one traffic criterion and based on the at least one device characteristic being determined to satisfy the at least one resource management measurement gap measurement skipping criterion, transmitting, to the user equipment, at least one resource management measurement gap measurement modification indication indicative of at least one resource management measurement gap measurement modification to be implemented by the user equipment during at least one resource management measurement gap.

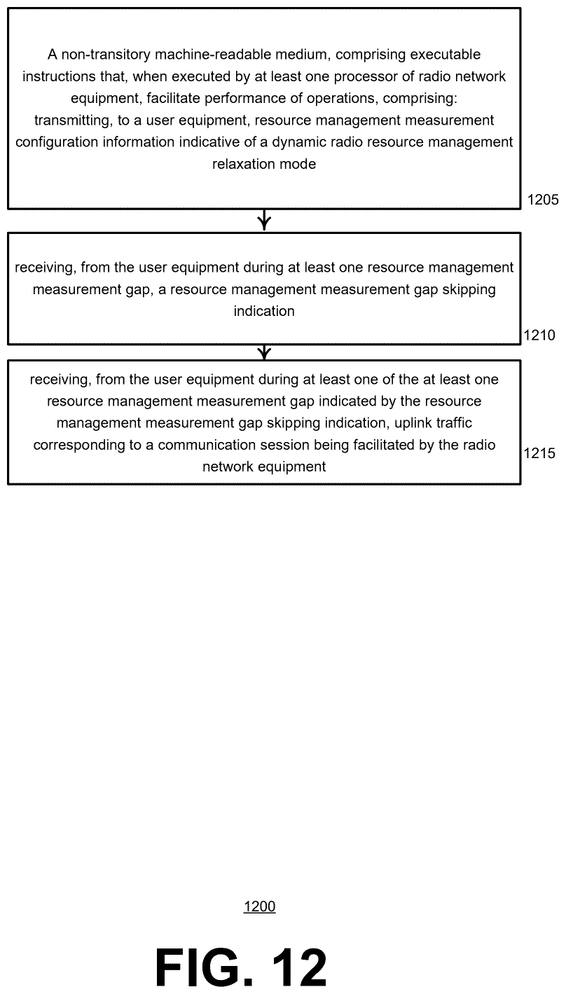

Turning now to FIG. 12, the figure illustrates a non-transitory machine-readable medium 1200 comprising at block 1205 executable instructions that, when executed by at least one processor of a radio network node, facilitate performance of operations, comprising, transmitting, to a user equipment, resource management measurement configuration information indicative of a dynamic radio resource management relaxation mode; at block 1210 receiving, from the user equipment during at least one resource management measurement gap, a resource management measurement gap skipping indication; and at block 1215 receiving, from the user equipment during at least one of the at least one resource management measurement gap indicated by the resource management measurement gap skipping indication, uplink traffic corresponding to a communication session being facilitated by the radio network equipment.

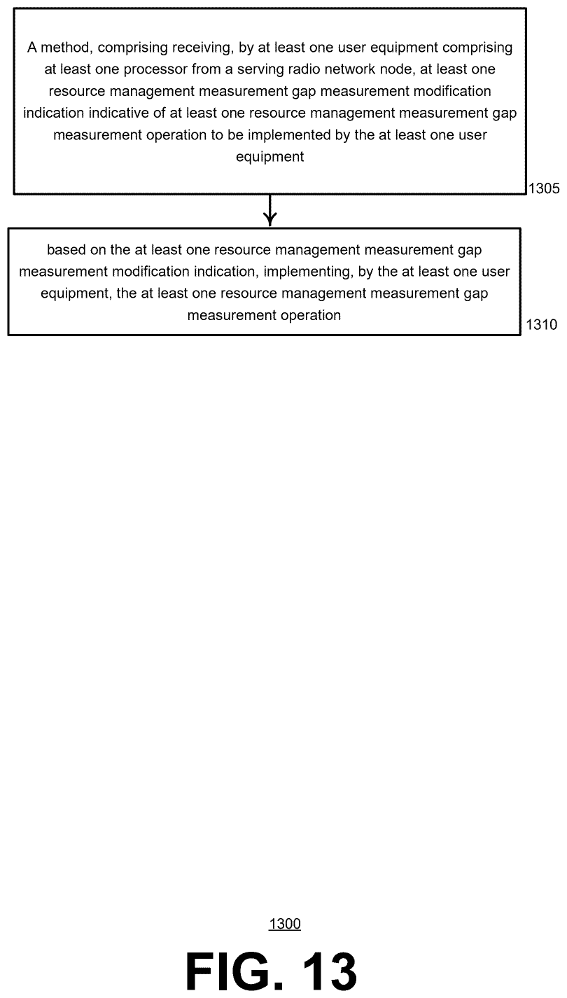

Turning now to FIG. 13, the figure illustrates an example embodiment method 1300 comprising at block 1305 receiving, by at least one user equipment comprising at least one processor from a serving radio network node, at least one resource management measurement gap measurement modification indication indicative of at least one resource management measurement gap measurement operation to be implemented by the at least one user equipment; and at block 1310 based on the at least one resource management measurement gap measurement modification indication, implementing, by the at least one user equipment, the at least one resource management measurement gap measurement operation.

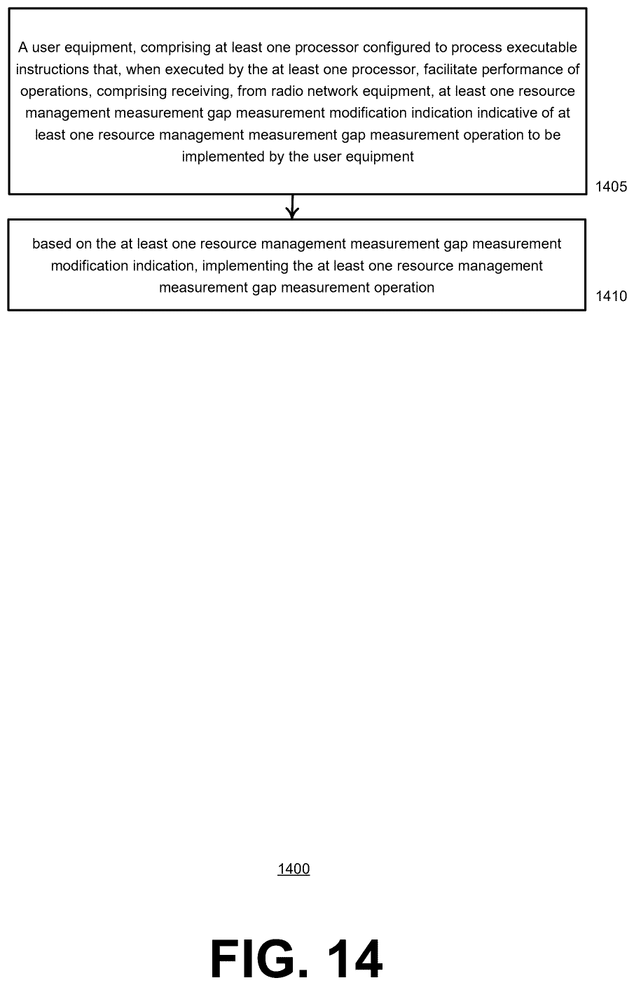

Turning now to FIG. 14, the figure illustrates a user equipment 1400, comprising at block 1405 at least one processor configured to process executable instructions that, when executed by the at least one processor, facilitate performance of operations, comprising receiving, from radio network equipment, at least one resource management measurement gap measurement modification indication indicative of at least one resource management measurement gap measurement operation to be implemented by the user equipment; and at block 1410, based on the at least one resource management measurement gap measurement modification indication, implementing the at least one resource management measurement gap measurement operation.

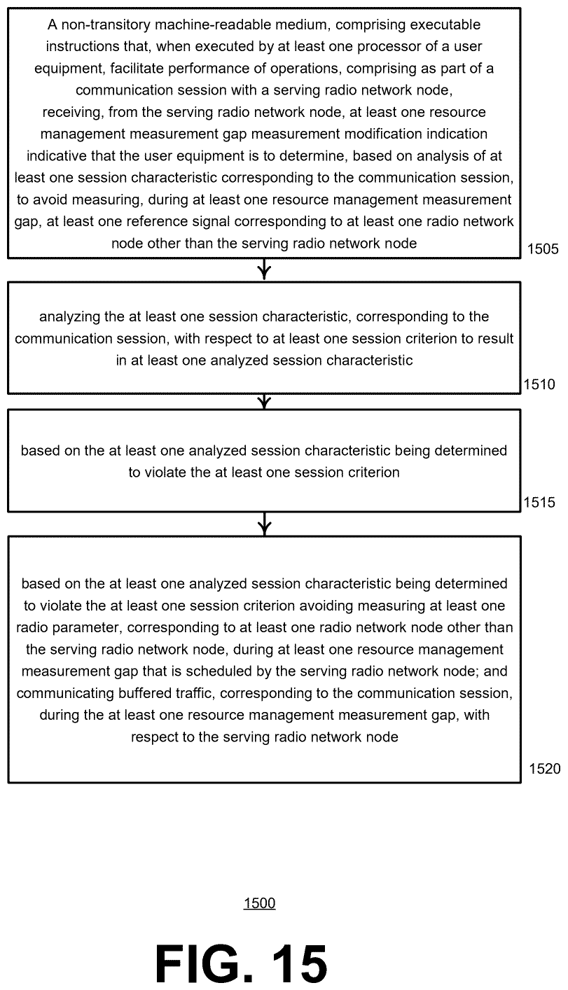

Turning now to FIG. 15, the figure illustrates a non-transitory machine-readable medium 1500 comprising at block 1505 executable instructions that, when executed by at least one processor of a user equipment, facilitate performance of operations, comprising, comprising as part of a communication session with a serving radio network node, receiving, from the serving radio network node, at least one resource management measurement gap measurement modification indication indicative that the user equipment is to determine, based on analysis of at least one session characteristic corresponding to the communication session, to avoid measuring, during at least one resource management measurement gap, at least one reference signal corresponding to at least one radio network node other than the serving radio network node; at block 1510 analyzing the at least one session characteristic, corresponding to the communication session, with respect to at least one session criterion to result in at least one analyzed session characteristic; at block 1515 based on the at least one analyzed session characteristic being determined to violate the at least one session criterion; and at block 1520 based on the at least one analyzed session characteristic being determined to violate the at least one session criterion avoiding measuring at least one radio parameter, corresponding to at least one radio network node other than the serving radio network node, during at least one resource management measurement gap that is scheduled by the serving radio network node; and communicating buffered traffic, corresponding to the communication session, during the at least one resource management measurement gap, with respect to the serving radio network node.

In order to provide additional context for various embodiments described herein, FIG. 16 and the following discussion are intended to provide a brief, general description of a suitable computing environment 1600 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors and may include a cache memory. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

Computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid-state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can comprise a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are examples and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning now to FIG. 17, the figure illustrates a block diagram of an example UE 1760. UE 1760 may comprise a smart phone, a wireless tablet, a laptop computer with wireless capability, a wearable device, a machine device that may facilitate vehicle telematics, and the like. UE 1760 comprises a first processor 1730, a second processor 1732, and a shared memory 1734. UE 1760 includes radio front end circuitry 1762, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1762 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 17, UE 1760 may also include a SIM 1764, or a SIM profile, which may comprise information stored in a memory (memory 1734 or a separate memory portion), for facilitating wireless communication with RAN 105 or core network 130 shown in FIG. 1. FIG. 17 shows SIM 1764 as a single component in the shape of a conventional SIM card, but it will be appreciated that SIM 1764 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1764 and another device, which may be a component of RAN 105 or core network 130 shown in FIG. 1). A SIM profile 1764 may also comprise identifying information that is unique to the SIM, or SIM profile, such as, for example, an International Mobile Subscriber Identity (“IMSI”) or information that may make up an IMSI.

SIM 1764 is shown coupled to both the first processor portion 1730 and the second processor portion 1732. Such an implementation may provide an advantage that first processor portion 1730 may not need to request or receive information or data from SIM 1764 that second processor 1732 may request, thus eliminating the use of the first processor acting as a ‘go-between’ when the second processor uses information from the SIM in performing its functions and in executing applications. First processor 1730, which may be a modem processor or baseband processor, is shown smaller than processor 1732, which may be a more sophisticated application processor, to visually indicate the relative levels of sophistication (i.e., processing capability and performance) and corresponding relative levels of operating power consumption levels between the two processor portions. Keeping the second processor portion 1732 asleep/inactive/in a low power state when UE 1760 does not need it for executing applications and processing data related to an application provides an advantage of reducing power consumption when the UE only is going to use the first processor portion 1730 while in listening mode for monitoring routine configured bearer management and mobility management/maintenance procedures, or for monitoring search spaces that the UE has been configured to monitor while the second processor portion remains inactive/asleep.

UE 1760 may also include sensors 1766, such as, for example, temperature sensors, accelerometers, gyroscopes, barometers, moisture sensors, and the like that may provide signals to the first processor 1730 or second processor 1732. Output devices 1768 may comprise, for example, one or more visual displays (e.g., computer monitors, VR appliances, and the like), acoustic transducers, such as speakers or microphones, vibration components, and the like. Output devices 1768 may comprise software that interfaces with output devices, for example, visual displays, speakers, microphones, touch sensation devices, smell or taste devices, and the like, that are external to UE 1760.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by at least one user equipment comprising at least one processor from a serving radio network node, at least one resource management measurement gap measurement modification indication indicative of at least one resource management measurement gap measurement operation to be implemented by the at least one user equipment; and
based on the at least one resource management measurement gap measurement modification indication, implementing, by the at least one user equipment, the at least one resource management measurement gap measurement operation.

2. The method of claim 1, further comprising, receiving, by the at least one user equipment, at least one resource management measurement gap measurement criterion information message comprising at least one resource management measurement gap measurement criterion.

3. The method of claim 2, further comprising:
analyzing, by the at least one user equipment, at least one device characteristic with respect to the at least one resource management measurement gap measurement criterion to result in at least one analyzed device characteristic;
based on the at least one analyzed device characteristic being determined to satisfy the at least one resource management measurement gap measurement criterion, determining, by the at least one user equipment, to implement the at least one resource management measurement gap measurement operation, which comprises avoiding measuring at least one radio parameter, corresponding to at least one radio network node other than the serving radio network node, during at least one resource management measurement gap; and
communicating traffic, corresponding to at least one communication session during the at least one resource management measurement gap, with respect to the serving radio network node.

4. The method of claim 3, wherein the at least one resource management measurement gap measurement criterion comprises at least one of: at least one mobility criterion to be applied to an estimated speed of movement of the at least one user equipment, or at least one coverage level change criterion to be applied to an estimated rate of change of signal strength, at the at least one user equipment, associated with the serving radio network node.

5. The method of claim 3, wherein the determining to implement the at least one resource management measurement gap measurement operation during the at least one resource management measurement gap is further based on:
analyzing, by the at least one user equipment, at least one session characteristic, corresponding to the at least one communication session, with respect to at least one session criterion to result in at least one analyzed session characteristic; and
determining, by the at least one user equipment, that the at least one analyzed session characteristic does not satisfy at least one session criterion.

6. The method of claim 5, wherein the at least one session characteristic comprises at least one latency associated with at least one uplink traffic protocol data unit being buffered by the at least one user equipment, wherein the determining that the at least one analyzed session characteristic does not satisfy the at least one session criterion comprises the at least one user equipment determining that failure to transmit at least one protocol data unit, corresponding to the at least one communication session buffered by the at least one user equipment, during the at least one resource management measurement gap is threshold likely to result in the at least one session criterion not being satisfied, and wherein the at least one session criterion is based on at least one quality of service associated with the at least one communication session.

7. The method of claim 1, wherein the at least one resource management measurement gap measurement modification indication is received via at least one downlink control information message.

8. The method of claim 7, wherein the at least one resource management measurement gap measurement modification indication is indicative of at least one resource management measurement gap to result in at least one indicated resource management measurement gap, and wherein the at least one resource management measurement gap measurement operation comprises avoiding, during the at least one indicated resource management measurement gap, measuring at least one reference signal corresponding to at least one radio network node other than the serving radio network node.

9. The method of claim 8, wherein the at least one indicated resource management measurement gap has been scheduled, by the serving radio network node, to occur subsequent to the receiving, by the at least one user equipment, of the at least one resource management measurement gap measurement modification indication.

10. The method of claim 1, wherein the at least one resource management measurement gap measurement modification indication is indicative of at least one resource management measurement gap to result in at least one indicated resource management measurement gap, and wherein the at least one resource management measurement gap measurement modification indication is received during at least one of the at least one indicated resource management measurement gap via at least one medium access control control element.

11. The method of claim 10, further comprising:
analyzing, by the at least one user equipment, at least one device characteristic with respect to at least one resource management measurement gap measurement criterion to result in at least one analyzed device characteristic;
based on the at least one analyzed device characteristic being determined to satisfy the at least one resource management measurement gap measurement criterion, determining, by the at least one user equipment, to implement the at least one resource management measurement gap measurement operation during the at least one resource management measurement gap; and
communicating traffic, corresponding to at least one communication session during the at least one resource management measurement gap, with respect to the serving radio network node.

12. The method of claim 1, wherein the at least one resource management measurement gap measurement operation comprises at least one of: avoiding, by the at least one user equipment during at least one resource management measurement gap, measuring at least one radio parameter, corresponding to at least one radio network node other than the serving radio network node; or avoiding, by the at least one user equipment during the at least one resource management measurement gap, reporting at least one radio parameter value, corresponding to at least one radio network node other than the serving radio network node, measured by the at least one user equipment during the at least one resource management measurement gap.

13. A user equipment, comprising at least one processor configured to process executable instructions that, when executed by the at least one processor, facilitate performance of operations, comprising:
receiving, from radio network equipment, at least one resource management measurement gap measurement modification indication indicative of at least one resource management measurement gap measurement operation to be implemented by the user equipment; and
based on the at least one resource management measurement gap measurement modification indication, implementing the at least one resource management measurement gap measurement operation.

14. The user equipment of claim 13, wherein the at least one resource management measurement gap measurement modification indication is received via at least one downlink control information message, wherein the at least one resource management measurement gap measurement modification indication is indicative of at least one resource management measurement gap to result in at least one indicated resource management measurement gap, and
wherein the at least one resource management measurement gap measurement operation comprises at least one of: avoiding, during the at least one indicated resource management measurement gap, measuring at least one reference signal corresponding to at least one radio network node other than a serving radio network node associated with the radio network equipment, or reporting, during the at least one indicated resource management measurement gap, at least one measured reference signal parameter value corresponding to the at least one radio network node other than the serving radio network node.

15. The user equipment of claim 13, wherein the at least one resource management measurement gap measurement modification indication is indicative of at least one resource management measurement gap to result in at least one indicated resource management measurement gap, and wherein the at least one resource management measurement gap measurement modification indication is received during at least one of the at least one indicated resource management measurement gap via at least one medium access control control element.

16. The user equipment of claim 15, wherein the at least one resource management measurement gap measurement operation comprises at least one of: avoiding, during the at least one indicated resource management measurement gap, measuring at least one reference signal corresponding to at least one radio network node other than a serving radio network node associated with the radio network equipment; or reporting, during the at least one indicated resource management measurement gap, at least one measured reference signal parameter value corresponding to the at least one radio network node other than the serving radio network node.

17. The user equipment of claim 15, further comprising:
analyzing, by the user equipment, at least one device characteristic with respect to at least one resource management measurement gap measurement criterion to result in at least one analyzed device characteristic;
based on the at least one analyzed device characteristic being determined to satisfy the at least one resource management measurement gap measurement criterion, determining, by the user equipment, to implement the at least one resource management measurement gap measurement operation during the at least one resource management measurement gap; and
communicating traffic, corresponding to at least one communication session during the at least one resource management measurement gap, with respect to the radio network equipment.

18. A non-transitory machine-readable medium, comprising executable instructions that, when executed by at least one processor of a user equipment, facilitate performance of operations, comprising:
as part of a communication session with a serving radio network node,
receiving, from the serving radio network node, at least one resource management measurement gap measurement modification indication indicative that the user equipment is to determine, based on analysis of at least one session characteristic corresponding to the communication session, to avoid measuring, during at least one resource management measurement gap, at least one reference signal corresponding to at least one radio network node other than the serving radio network node;
analyzing the at least one session characteristic, corresponding to the communication session, with respect to at least one session criterion to result in at least one analyzed session characteristic; and
based on the at least one analyzed session characteristic being determined to violate the at least one session criterion:
avoiding measuring at least one radio parameter, corresponding to at least one radio network node other than the serving radio network node, during at least one resource management measurement gap that is scheduled by the serving radio network node; and
communicating buffered traffic, corresponding to the communication session, during the at least one resource management measurement gap, with respect to the serving radio network node.

19. The non-transitory machine-readable medium of claim 18, wherein the operations further comprise:
based on the at least one analyzed session characteristic being determined to violate the at least one session criterion, transmitting, to the serving radio network node, at least one resource management measurement gap skipping indication, via at least one preamble resource associated with the at least one resource management measurement gap, indicative of an absence, during at least one future resource management measurement gap, of at least one measured parameter value corresponding to at least one radio network node other than the serving radio network node being transmitted to the serving radio network node by the user equipment.

20. The non-transitory machine-readable medium of claim 19, wherein the at least one resource management measurement gap skipping indication is transmitted via at least one medium access control control element.
